(19) United States
(12) Patent Application Publication
(10) Pub. No.: US 2025/0059408 A1
(43) Pub. Date: Feb. 20, 2025

(54) THERMALLY DE-BONDABLE ADHESIVES

(71) Applicant: 3M INNOVATIVE PROPERTIES COMPANY, St. Paul, MN (US)

(72) Inventors: Jian-Kuan Wu, Taoyuan City (TW); Shujun J. Wang, Woodbury, MN (US); Aizoh Sakurai, Tokyo (JP)

(21) Appl. No.: 18/721,284

(22) PCT Filed: Dec. 1, 2022
(86) PCT No.: PCT/IB2022/061665

§ 371 Date: Jun. 18, 2024

Related U.S. Application Data
(60) Provisional application No. 63/291,530, filed on Dec. 20, 2021.

(51) Int. Cl. C09J 7/38; C09J 5/06; C09J 11/06

(52) U.S. Cl. CPC C09J 7/385; C09J 5/06; C09J 11/06; C09J 2301/302; C09J 2301/408; C09J 2301/416; C09J 2301/502

(57) ABSTRACT

Thermally de-bondable adhesives are formed from curable compositions that have a two-stage curing mechanism. The first stage of curing forms a pressure sensitive adhesive and the second stage of curing, reduces the adhesion of the adhesive. The curable composition includes a curable composition and a thermally de-bonding composition. The curable composition includes a first alkyl (meth)acrylate monomer with 4-12 carbon atoms, a second hydroxyl-functional (meth)acrylate monomer, a crosslinker, and an initiator. The thermally de-bonding composition includes a blocked multi-functional isocyanate, and a metal salt catalyst. The Peel Adhesion of the cured adhesive upon heating to at least 180° C. for 1 hour is reduced by at least 15%.

### SUMMARY

Disclosed herein are adhesive compositions that are thermally de-bondable. The adhesive compositions have a two-stage curing mechanism. The first stage of curing forms a pressure sensitive adhesive and the second stage of curing, at an elevated temperature, causes the pressure sensitive adhesive to have reduced adhesion. Also disclosed are articles that have include the cured adhesive compositions.

In some embodiments, the compositions of this disclosure comprise a curable adhesive composition that upon curing forms a (meth)acrylate pressure sensitive adhesive. The curable adhesive composition comprises a curable composition and a thermally de-bonding composition. The curable composition comprises at least one first monomer comprising an alkyl (meth)acrylate comprising 4-12 carbon atoms, at least one second monomer comprising a hydroxyl-functional (meth)acrylate, at least one crosslinking moiety, and at least one initiator. The thermally de-bonding composition comprises at least one blocked multi-functional isocyanate, and at least one metal salt catalyst. The Peel Adhesion of the cured (meth)acrylate pressure sensitive adhesive upon heating to at least 180° C. for 1 hour is reduced by at least 15%.

Also disclosed are articles. In some embodiments, the articles comprise a substrate with a first major surface and a second major surface, and a cured adhesive disposed on at least a portion of the second major surface of the substrate. The adhesive composition has been described above. In some embodiments, the adhesive comprises a cured (meth)acrylate pressure sensitive adhesive, formed by curing a composition that comprises a curable composition and a thermally de-bonding composition. The curable composition comprises at least one first monomer comprising an alkyl (meth)acrylate comprising 4-12 carbon atoms, at least one second monomer comprising a hydroxyl-functional (meth)acrylate, at least one crosslinking moiety, and at least one initiator. The thermally de-bonding composition comprises at least one blocked multi-functional isocyanate, and at least one metal salt catalyst. The Peel Adhesion of the cured (meth)acrylate pressure sensitive adhesive upon heating to at least 180° C. for 1 hour is reduced by at least 15%.

### DETAILED DESCRIPTION

The use of adhesives, especially pressure sensitive adhesives, in areas such as the medical, electronic, automotive, energy, and optical industries is increasing. The requirements of these industries place additional demands upon the pressure sensitive adhesive beyond the traditional properties of tack, peel adhesion and shear holding power. New classes of materials are desirable to meet the increasingly demanding performance requirements for pressure sensitive adhesives. Among the performance requirements for new classes of pressure sensitive adhesives are de-bondability.

As used herein, the term “de-bondability” when used to describe a pressure sensitive adhesive means that the pressure sensitive adhesive upon application of heat decreases in adhesiveness, permitting easier removal by peeling.

In this disclosure, heat de-bondable adhesives are described. The adhesives are pressure sensitive adhesives at room temperature, but upon heating to an elevated temperature, the adhesiveness of the adhesive decreases. The decreased adhesion is produced by incorporating into a cured adhesive layer a second curing mechanism, such that when the second curing mechanism is activated by heat, the increased curing causes a decrease in peel adhesion. The de-bondable adhesives include curable components and a thermally de-bondable composition. In a first stage of curing, the curable components cure to form the pressure sensitive adhesive. In the second stage of curing, the thermally de-bondable composition cures resulting in a decreased peel adhesion compared to the pressure sensitive adhesive after first stage curing. Also disclosed are adhesive articles that comprise a substrate and a layer of the heat de-bondable adhesive.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate functional” are materials that contain one or more (meth)acrylate groups.

The terms “room temperature” and “ambient temperature” are used interchangeably to mean temperatures in the range of 20° C. to 25° C.

The terms “Tg” and “glass transition temperature” are used interchangeably. If measured, Tg values are determined by Differential Scanning calorimetry (DSC) at a scan rate of 10° C./minute, unless otherwise indicated. Typically, Tg values for copolymers are not measured but are calculated using the well-known Fox Equation, using the monomer Tg values provided by the monomer supplier, as is understood by one of skill in the art.

The term “Tm” refers to melt temperature, the temperature at which a solid becomes a liquid.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The terms “free radically polymerizable” and “ethylenically unsaturated” are used interchangeably and refer to a reactive group which contains a carbon-carbon double bond which is able to be polymerized via a free radical polymerization mechanism.

Disclosed herein are adhesive compositions that are heat de-bondable. The adhesive composition comprises a curable composition and a thermally de-bonding composition. The curable composition that upon curing forms a (meth)acrylate pressure sensitive adhesive. The curable components polymerize to form the (meth)acrylate pressure sensitive adhesive in what is called herein “first stage curing”. Upon heating to an elevated temperature of at least 180° C. for 1 hour, the second stage of curing, involving the thermally de-bonding composition, is activated causing a reduction of at least 15% in the Peel Adhesion. In some embodiments, the Peel Adhesion of the cured (meth)acrylate pressure sensitive adhesive upon heating to at least 180° C. for 1 hour is reduced by at least 40%.

In some embodiments, the curable composition comprises 70-98.9% by weight of the total composition and comprises 50-99% by weight of the curable composition of at least one alkyl (meth)acrylate comprising 4-12 carbon atoms, 1-40% by weight of the curable composition of at least one hydroxyl-functional (meth)acrylate, 0.1-20 parts by weight per 100 parts of the curable components of at least one crosslinking moiety, and at least one initiator. The thermally de-bonding composition comprises 1-20% by weigh of the total composition of at least one blocked multifunctional isocyanate, and 1-10% by weight of the total composition of the least one metal salt catalyst. Each of these components is described in detail below. Additionally, other optional components can be included in the adhesive composition.

The curable components of the curable composition comprise at least one first monomer comprising an alkyl (meth)acrylate comprising 4-12 carbon atoms, at least one second monomer comprising a hydroxyl-functional (meth)acrylate, at least one crosslinking moiety, and at least one initiator.

The curable composition mixture comprises at least one monoethylenically unsaturated alkyl acrylate or methacrylate where the alkyl group of the (meth)acrylate has an average of about 4 to about 12 carbon atoms. The alkyl group can optionally contain oxygen atoms in the chain thereby forming ethers or alkoxy ethers, for example. Examples of suitable (meth)acrylates include, but are not limited to, 2-methylbutyl acrylate, isooctyl acrylate, lauryl acrylate, stearyl acrylate, 4-methyl-2-pentyl acrylate, isoamyl acrylate, isobornyl acrylate, tert-butyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, and isononyl acrylate. Particularly suitable monoethylenically unsaturated (meth)acrylates that can be used as the first monomer include 2-ethylhexyl acrylate, and tert-butyl acrylate, isobornyl acrylate, and stearyl acrylate.

The curable composition also comprises at least one hydroxyl-functional second monomer. Examples of suitable second monomers include that are hydroxyl-substituted alkyl group comprising 2-6 carbon atoms. Examples of particularly suitable alkyl acrylate monomers for use as the second (meth)acrylate monomer are 2-hydroxyethyl acrylate, 2-hydroxylpropyl acrylate, and 4-hydroxybutyl acrylate.

The curable composition also comprises at least one crosslinking moiety. Suitable crosslinking moieties include multi-functional (meth)acrylates, compounds comprising at least 2 hydroxyl-reactive groups, or a photo-activatable crosslinking moiety.

One class of useful crosslinking agents are multi-functional (meth)acrylate species. Multi-functional (meth)acrylates include tri(meth)acrylates and di(meth)acrylates (that is, compounds comprising three or two (meth)acrylate groups). Typically, di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl) isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

Another useful class of crosslinking agents contain functionality which is reactive with hydroxyl groups. Examples of such crosslinkers include multifunctional aziridine, isocyanate, and epoxy compounds. Examples of aziridine-type crosslinkers include, for example 1,1′-(1,3-phenylene dicarbonyl)-bis-(2-methylaziridine). The aziridine crosslinker 1,1′-(1,3-phenylene dicarbonyl)-bis-(2-methylaziridine) (CAS No. 7652-64-4), commonly referred to as “Bisamide” is particularly useful. Common polyfunctional isocyanate crosslinkers include, for example, trimethylolpropane toluene diisocyanate, toluene diisocyanate, and hexamethylene diisocyanate.

In some embodiments, the crosslinking agent can be a photocrosslinking agent, which, upon exposure to ultraviolet radiation (e. g., radiation having a wavelength of about 250 nanometers to about 400 nanometers), causes the copolymer to crosslink. Particularly suitable are the photosensitive crosslinkers which are activated by high intensity ultraviolet (UV) light. Two common photosensitive crosslinkers used are benzophenone and copolymerizable aromatic ketone monomers as described in U.S. Pat. No. 4,737,559. A particularly suitable photosensitive crosslinker is AEBP (Acrylated Ethoxylated Benzophenone).

The curable composition also comprises at least one initiator. In some embodiments, the initiator may comprise a photoinitiator, meaning that the initiator is activated by light, typically ultraviolet (UV) light. Suitable free-radical photoinitiators can be selected from benzophenone, 4-methylbenzophenone, benzoyl benzoate, phenylacetophenones, 2,2-dimethoxy-2-phenylacetophenone, alpha,alpha-diethoxyacetophenone, 1-hydroxy-cyclohexyl-phenyl-ketone (available under the trade designation IRGACURE 184 from BASF Corp., Florham Park, NJ), 2-hydroxy-2-methyl-1-phenylpropan-1-one, bis-(2,6-dimethoxybenzoyl)-2,4,4-trimethylpentyl phosphine oxide, 2-hydroxy-2-methyl-1-phenylpropan-1-one, 2-hydroxy-2-methyl-1-phenylpropan-1-one (available under the trade designation DAROCURE 1173 from BASF Corp.), 2,4,6-trimethylbenzoyl-diphenylphosphine oxide, and combinations thereof (e.g., a 50:50 by wt. mixture of 2,4,6-trimethylbenzoyl-diphenylphosphine oxide and 2-hydroxy-2-methyl-1-phenylpropan-1-one, available under the trade designation DAROCURE 4265 from BASF Corp.). Additional examples of suitable free radical photoinitiators include DAROCURE 4265, IRGACURE 651, IRGACURE 1173, IRGACURE 819, LUCIRIN TPO, LUCIRIN TPO-L, commercially available from BASF, Charlotte, NC. A particularly suitable photoinitiator is AIBN (azobisisobutyronitrile) commercially available as VAZO 64 from Chemours.

The curable composition may also include optional curable materials. In some embodiments, the curable composition further comprises at least one reinforcing monomer. Examples of reinforcing monomers include acidic monomers, non-acidic polar monomers, or high Tg monomers with a homopolymer Tg or Tm of greater than 20° C. In some embodiments, the reinforcing monomer comprises 0-49% by weight of the curable composition.

A wide range of acidic monomers are suitable. Useful acidic monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, beta-carboxyethyl acrylate, 2-sulfoethyl methacrylate, styrenesulfonic acid, 2-acrylamido-2-methylpropanesulfonic acid, vinylphosphonic acid, and the like, and mixtures thereof. Due to their availability, typically ethylenically unsaturated carboxylic acids are used.

A wide range of basic monomers are suitable. Exemplary basic monomers include N,N-dimethylaminopropyl methacrylamide (DMAPMAm); N,N-diethylaminopropyl methacrylamide (DEAPMAm); N,N-dimethylaminoethyl acrylate (DMAEA); N,N-diethylaminoethyl acrylate (DEAEA); N,N-dimethylaminopropyl acrylate (DMAPA); N,N-diethylaminopropyl acrylate (DEAPA); N,N-dimethylaminoethyl methacrylate (DMAEMA); N,N-diethylaminoethyl methacrylate (DEAEMA); N,N-dimethylaminoethyl acrylamide (DMAEAm); N, N-dimethylaminoethyl methacrylamide (DMAEMAm); N,N-diethylaminoethyl (DEAEAm); N,N-diethylaminoethyl methacrylamide (DEAEMAm); N,N-dimethylaminoethyl vinyl ether (DMAEVE); N,N-diethylaminoethyl vinyl ether (DEAEVE); and mixtures thereof. Other useful basic monomers include vinylpyridine, vinylimidazole, tertiary amino-functionalized styrene (e.g., 4-(N,N-dimethylamino)-styrene (DMAS), 4-(N,N-diethylamino)-styrene (DEAS)), N-vinylpyrrolidone, N-vinylcaprolactam, acrylonitrile, N-vinylformamide, (meth)acrylamide, and mixtures thereof.

A wide range of high Tg monomers are suitable. The high Tg monomers with a Tg or a Tm of greater than 20° C. include vinyl monomers and alkyl (meth)acrylate monomers which, as homopolymers, have a Tg greater than 20° C., such as n-butyl methacrylate, methyl methacrylate, isobornyl acrylate, vinyl acetate, styrene, and the like. Examples of suitable monomers include, but are not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, bromoethyl methacrylate, 2-hydroxyethyl methacrylate, hydroxypropyl methacrylate, glycidyl methacrylate, allyl methacrylate, styrene, vinyl acetate, vinyl chloride.

The adhesive composition also comprises a thermally de-bonding composition. The thermally de-bonding composition is a second stage curing composition that is activated at an elevated temperature, and upon second stage curing the peel adhesion of the adhesive is decreased. This decrease in peel adhesion permits easier removal of articles bonded by the cured adhesive composition. Typically, the thermally de-bonding composition comprises at least 2 components, at least one blocked multifunctional isocyanate, and at least one metal salt catalyst.

A wide range of blocked multi-functional isocyanate compounds are suitable. Particularly suitable are amino-blocked polyisocyanates. Exemplary blocked polyisocyanate compounds include those based upon aromatic polyisocyanates such as TDI (tolylene diisocyanate) or aliphatic polyisocyanates such as IPDI (isopherone diisocyanate) and HDI (hexane diisocyanate). Additionally, biurets can also be suitable. Examples of commercially available blocked multi-functional isocyanates include DURENE L75 (TDI-based material) from Ryada Chemicals; DESMODUR BL 3272 (an HDI-based material) and DESMODUR BL 2078 (an IPDI-based material) from Covesto AG; and the biurets TRIXENE BI 7981, TRIXENE BI 7960, TRIXENE BI 7963, and TRIXENE BI 7982 from Tri-iso Inc.

A wide range of metal salt catalysts are suitable. Typically, the metal salt catalysts include the metal salt catalysts that catalyze the polymerization of isocyanates and alcohols to form urethanes. In the current compositions, the metal salt catalysts can also act as crosslinkers for the (meth)acrylate-based pressure sensitive adhesives as well as catalysts for the second stage crosslinking reaction. Examples of suitable metal salt catalyst include aluminum acetonate, dibutyltin dilaurate, bismuth carboxylate, zirconium acetyl acetonate, dibutyltin diacetate, antimony acetate, calcium octoate, titanium tetrabutoxide and chromium dionate or combinations thereof.

Also disclosed herein are articles. The articles comprise a substrate with a first major surface and a second major surface and a cured adhesive composition disposed on at least a portion of the second major surface of the substrate. The adhesive has been described above and comprises an adhesive composition that upon curing forms a (meth)acrylate pressure sensitive adhesive, the adhesive composition comprising a curable composition and a thermally de-bonding composition. The curable composition comprises at least one first monomer comprising an alkyl (meth)acrylate comprising 4-12 carbon atoms, at least one second monomer comprising a hydroxyl-functional (meth)acrylate, at least one crosslinking moiety, and at least one initiator. The thermally de-bonding composition comprises at least one blocked multifunctional isocyanate and at least one metal salt catalyst. As described above, the Peel Adhesion of the cured (meth)acrylate pressure sensitive adhesive upon heating to at least 180° C. for 1 hour is reduced by at least 15%.

A wide range of substrates are suitable. Examples of suitable substrates include films, tape backings, foams, release liners, or rigid plates. Each of these classes of substrates are described below.

Films, as used herein, are thin polymeric substrates that are flexible. Representative examples of polymeric substrates include those that contain polyesters (e.g., polyethylene terephthalates and polyethylene naphthalates), polycarbonates, poly(meth)acrylates (e.g., polymethyl methacrylates), polyurethanes, polyvinyl alcohols, polyolefins such as polyethylenes and polypropylenes, polyvinyl chlorides, polyimides, cellulose triacetates, acrylonitrile-butadiene-styrene copolymers, and the like.

Examples of suitable tape backings can include the materials that overlap with the other classes of suitable substrates. Examples of tape backings include polymeric films, metal films, paper, creped paper, foams, and the like.

A wide range of foams are suitable. Examples of suitable foams include open- or closed-cell foams, such as those disclosed in U.S. Pat. Nos. 6,548,727 and 5,409,472.

Release liners are well known in the adhesive arts and are substrates that have at least one release surface to which pressure sensitive adhesives do not permanently adhere but are used to protect adhesive surfaces and from which adhesives are readily removed. A wide range of release liners are suitable. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like). At least some release liners are coated with a layer of a release agent such as a silicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film.

A wide variety of rigid plates are suitable. Examples of rigid substrates include glass plates, relatively thick polymeric plates such as plates of polycarbonate (PC) or polymethylmethacrylate (PMMA), ceramics, metal plates, or the like.

The articles of this disclosure have a wide range of uses. The articles are adhesive articles and as such, in some embodiments, upon applying the article to a surface, the Peel Adhesion of the cured (meth)acrylate pressure sensitive adhesive layer is at least 2.5 Newtons/inch.

As mentioned above, upon exposure to an elevated temperature, the peel adhesion of the adhesive layer is decreased. This decrease in peel adhesion facilitates the removal of the adhesive article from the surface to which it is adhered. In some embodiments, upon heating to an elevated temperature of at least 180° C. for 1 hour, the second stage of curing, involving the thermally de-bonding composition, is activated causing a reduction of at least 15% in the Peel Adhesion. In other embodiments, the Peel Adhesion of the cured (meth)acrylate pressure sensitive adhesive upon heating to at least 180° C. for 1 hour is reduced by at least 40%.

### Examples

These examples are merely for illustrative purposes only and are not meant to be limiting on the scope of the appended claims. All parts, percentages, ratios, etc. in the examples and the rest of the specification are by weight, unless noted otherwise. The following abbreviations are used: CTH=Controlled Temperature and Humidity, PHR=Parts Per Hundred Resin, or parts by weight per 100 parts by weight of the curable (meth)acrylate components; mJ=milliJoules; cm=centimeters. The terms “weight %”, “% 10 by weight”, and “wt %” are used interchangeably.

Table of Abbreviations

| Abbreviation | |
|---|---|
| or Trade | |
| Designation | Description |
| PEN Film | Polyethylene naphthalate film with a thickness of 25 |
| | micrometers |
| 2-EHA | 2-ethylhexyl acrylate |
| HBA | 4-hydroxybutyl acrylate |
| HEA | 2-hydroxyethyl acrylate |
| HPA | 2-hydroxypropyl acrylate |
| TBA | tert-butyl acrylate |
| IBOA | isobornyl acrylate |
| DMAA | N,N-dimethylacrylamide |
| SA | stearyl acrylate |
| AA | acrylic acid |
| GMA | Glycidyl methacrylate |
| Initiator-1 | Thermal initiator of AIBN (Azobisisobutyronitrile) |
| | commercially available as “VAZO-64” from Chemours. |
| NVP | N-Vinylpyrrolidone |
| AEBP | Acrylated ethyloxalated Benzophenone |
| L75 | an aromatic polyisocyanate based on toluene |
| | diisocyanate |
| Al(acac)₃ | Aluminum acetylacetonate |
| AAX | Crosslinker for acrylic acid, N,N′-bis-propylene iso- |
| | phthalamide |
| BI1 | Blocked Isocyanate-1, HDI trimer blocked with |
| | caprolactam, available as TRIXENE BI 7981 from |
| | Tri-iso |
| BI2 | Blocked Isocyanate-2, HDI is blocked with |
| | caprolactam, available as DESMODUR BL 3272 from |
| | Covesto |
| BI3 | Blocked Isocyanate-3, IPDI is blocked with |
| | caprolactam, available as DESMODUR BL 2078 from |
| | Covesto |
| BI4 | Blocked Isocyanate-4, HDI biuret is blocked with 3,5- |
| | dimethylpyrazole, available as TRIXENE BI 7960 from |
| | Tri-iso |
| BI5 | Blocked Isocyanate-5, HDI biuret is blocked with diethyl |
| | malonate, available as TRIXENE BI 7963 from Tri-iso |
| BI6 | Blocked Isocyanate-6, HDI trimer is blocked with 3,5- |
| | dimethylpyrazole, available as TRIXENE BI 7982 from |
| | Tri-iso |

### Test Methods

### 180° Peel Adhesion

This peel adhesion test is similar to the test method described in ASTM D 3330-90, using a stainless steel substrate as described in the test.

Adhesive coatings on PEN film were cut into 1.27 centimeter by 15 centimeter strips. Each strip was then adhered to a 10 centimeter by 20 centimeter clean, stainless steel panel using a 2-kilogram roller passed once over the strip. The bonded assembly dwelled under CTH conditions (23° C.±−2° C., 50% relative humidity ±5%) for about 20 minutes and was tested for 180° peel adhesion using an IMASS slip/peel tester (Model 3M90, commercially available from Instrumentors Inc., Strongsville, OH) at a rate of 305 millimeters/minute (12 inches/minute) over a five second data collection time. Two samples were tested; the reported peel adhesion value is an average of the peel adhesion value from each of the two samples. Results are presented in Newtons per inch (N/in).

Peel Testing after Exposure to Elevated Temperature

### 180° C. 1 hr Testing:

Laminated tape samples were prepared at ambient temperature (23° C.±−2° C., 50% relative humidity ±5%), and placed on a plate and exposed to 180° C. for 1 hr. After conditioning samples for 1 hr at 180° C. and equilibrating at ambient temperature (23° C.±−2° C., 50% relative humidity ±5%) for at least 0.5 hr, peel adhesion testing was carried out at ambient temperature (23° C.±−2° C., 50% relative humidity ±5%).

### Examples

### Preparation of Pressure Sensitive Adhesives

Preparation of acrylate-based pressure sensitive adhesives were prepared by preparing the mixtures described in the following tables in ethyl acetate at a level of 40% solids by weight. To the acrylate components was added 0.15% by weight of Initiator-1, and the mixture was polymerized at 60° C. for 24 hours.

### Preparation of Tape Samples

To the acrylate-based pressure sensitive adhesive solutions prepared above, were mixed in the thermal de-bonding compositions shown in the following tables together with ethyl acetate to prepare solutions at a level of 30% by weight. These solutions were coated on PEN film, and dried to give tape samples with an adhesive thickness of 40 micrometers.

### Examples E1-E10

A series of tape samples that were prepared from pressure sensitive adhesives prepared from an alkyl acrylate, a hydroxyl acrylate, a crosslinker and a blocked isocyanate were prepared and tested as described above. The compositions are shown in Table 1 and the tape testing results are shown in Table 2.

TABLE 1

| | | | | | Blocked |
|---|---|---|---|---|---|
| | | | Crosslinking Component | | Isocyanate |
| Ex. | Acrylate Component | | L75 | Al(Acac)₃ | BI1 |
| No. | Monomers | Ratio | (PHR) | (PHR) | (PHR) |
| E1 | 2-EHA:HBA | 90:10 | 0.1 | 0.1 | 5 |
| E2 | 2-EHA:HBA | 90:10 | 0.2 | 0.1 | 5 |
| E3 | 2-EHA:HBA | 94:6 | 0.25 | 0.1 | 5 |
| E4 | 2-EHA:HBA | 94:6 | 0.4 | 0.1 | 5 |
| E5 | 2-EHA:HBA | 94:6 | 0.6 | 0.1 | 5 |
| E6 | 2-EHA:HBA | 94:6 | 0.8 | 0.1 | 5 |
| E7 | 2-EHA:HPA | 90:10 | 0.1 | 0.1 | 5 |
| E8 | 2-EHA:HPA | 90:10 | 0.25 | 0.1 | 5 |
| E9 | 2-EHA:HEA | 94:6 | 0.1 | 0.1 | 5 |
| E10 | 2-EHA:HEA | 94:6 | 0.25 | 0.1 | 5 |

TABLE 2

Peel Adhesion

| | Room Temp | 180° C. for 1 hour |
|---|---|---|
| Ex. No. | (N/in) | (N/in) |
| E1 | 6.50 | 2.23 |
| E2 | 4.34 | 2.34 |
| E3 | 6.30 | 2.06 |
| E4 | 4.20 | 2.35 |
| E5 | 3.02 | 2.05 |
| E6 | 2.57 | 2.13 |
| E7 | 26.97 | 1.89 |
| E8 | 9.70 | 2.27 |
| E9 | 8.78 | 2.03 |
| E10 | 6.54 | 2.07 |

### Examples E11-E16 and Comparative Examples CE1-CE4

A series of tape samples that were prepared from pressure sensitive adhesives prepared from an alkyl acrylate, a hydroxyl acrylate, a reinforcing monomer (acrylic acid), a crosslinker and a blocked isocyanate were prepared and tested as described above. The compositions are shown in Table 3 and the tape testing results are shown in Table 4.

TABLE 3

| | | | Crosslinking | | | Blocked |
|---|---|---|---|---|---|---|
| | Acrylate | | Component | | | Isocyanate |
| Ex. | Component | | L75 | AAX | Al(Acac)₃ | BI1 |
| No. | Monomers | Ratio | (PHR) | (PHR) | (PHR) | (PHR) |
| E11 | 2-EHA:AA:HBA | 92:2:6 | 0.1 | | 0.1 | 2 |
| E12 | 2-EHA:AA:HBA | 92:2:6 | 0.1 | | 0.1 | 3 |
| E13 | 2-EHA:AA:HBA | 92:2:6 | 0.1 | | 0.1 | 4 |
| E14 | 2-EHA:AA:HBA | 92:2:6 | | | 0.1 | 4 |
| E15 | 2-EHA:AA:HBA | 92:2:6 | | | 0.3 | 4 |
| E16 | 2-EHA:AA:HBA | 92:2:6 | 0.3 | | 0.1 | 4 |
| CE1 | 2-EHA:AA | 94:6 | | 0.6 | | 11 |
| CE2 | 2-EHA:AA | 94:6 | | 0.8 | | 11 |
| CE3 | 2-EHA:AA | 94:6 | | 1.0 | | 11 |
| CE4 | 2-EHA:AA | 94:6 | | 1.2 | | 11 |

TABLE 4

Peel Adhesion

| | Room Temp | 180° C. for 1 hour |
|---|---|---|
| Ex. No. | (N/in) | (N/in) |
| E11 | 7.67 | 4.34 |
| E12 | 8.86 | 3.78 |
| E13 | 7.90 | 3.15 |
| E14 | 9.30 | 3.35 |
| E15 | 7.90 | 3.15 |
| E16 | 6.10 | 3.18 |
| CE1 | 5.37 | 5.35 |
| CE2 | 4.54 | 5.89 |
| CE3 | 4.81 | 6.15 |
| CE4 | 3.23 | 5.90 |

### Examples E17-E28

A series of tape samples that were prepared from pressure sensitive adhesives prepared from an alkyl acrylate, a hydroxyl acrylate, a reinforcing monomer (acrylic acid), a crosslinker and a blocked isocyanate were prepared and tested as described above. The blocked isocyanate component was varied. The compositions are shown in Table 5 and the tape testing results are shown in Table 6.

TABLE 5

| | | | Crosslinking | | | | | | | |
|---|---|---|---|---|---|---|---|---|---|---|
| | Acrylate | | Component | | Blocked Isocyanate | | | | | |
| Ex | Component | | L75 | Al(Acac)₃ | BI1 | BI2 | BI3 | BI4 | BI5 | BI6 |
| No. | Monomer | Ratio | (PHR) | (PHR) | (PHR) | (PHR) | (PHR) | (PHR) | (PHR) | (PHR) |
| E17 | 2-EHA:HBA | 90:10 | 0.1 | 0.1 | 3 | | | | | |
| E18 | 2-EHA:HBA | 90:10 | 0.1 | 0.1 | 5 | | | | | |
| E19 | 2-EHA:HBA | 90:10 | 0.1 | 0.1 | 8 | | | | | |
| E20 | 2-EHA:HBA | 90:10 | 0.1 | 0.1 | | 3 | | | | |
| E21 | 2-EHA:HBA | 90:10 | 0.1 | 0.1 | | | 3 | | | |
| E22 | 2-EHA:HBA | 94:6 | 0.1 | 0.1 | | 3 | | | | |
| E23 | 2-EHA:HEA | 94:6 | 0.1 | 0.1 | 5 | | | | | |
| E24 | 2-EHA:HEA | 94:6 | 0.1 | 0.1 | | 5 | | | | |
| E25 | 2-EHA:HEA | 94:6 | 0.1 | 0.1 | | | 5 | | | |
| E26 | 2-EHA:HBA | 94:6 | 0.15 | 0.1 | | | | 3 | | |
| E27 | 2-EHA:HBA | 94:6 | 0.15 | 0.1 | | | | | 3 | |
| E28 | 2-EHA:HBA | 94:6 | 0.15 | 0.1 | | | | | | 3 |

TABLE 6

Peel Adhesion

| | Room Temp | 180° C. for 1 hour |
|---|---|---|
| Ex. No. | (N/in) | (N/in) |
| E17 | 6.31 | 3.01 |
| E18 | 6.50 | 2.23 |
| E19 | 7.00 | 0.92 |
| E20 | 8.31 | 2.77 |
| E21 | 6.25 | 3.92 |
| E22 | 5.71 | 2.03 |
| E23 | 8.78 | 2.03 |
| E24 | 8.44 | 1.88 |
| E25 | 7.90 | 3.89 |
| E26 | 20.15 | 2.40 |
| E27 | 6.07 | 3.57 |
| E28 | 8.19 | 2.02 |

### Examples E29-E38

A series of tape samples that were prepared from pressure sensitive adhesives prepared from an alkyl acrylate, a hydroxyl acrylate, a reinforcing monomer (High Tg acrylate), a crosslinker and a blocked isocyanate were prepared and tested as described above. The compositions are shown in Table 7 and the tape testing results are shown in Table 8.

TABLE 7

| | | | Crosslinking | | Blocked | |
|---|---|---|---|---|---|---|
| | Acrylate | | Components | | Isocyanate | |
| Ex. | Components | | L75 | Al(Acac)₃ | BI1 | BI3 |
| No. | Monomers | Ratio | (PHR) | (PHR) | PHR | (PHR) |
| E29 | 2-EHA:SA:HBA | 60:30:10 | 0.1 | 0.1 | | 3 |
| E30 | 2-EHA:SA:HBA | 70:20:10 | 0.1 | 0.1 | | 3 |
| E31 | 2-EHA:SA:HBA | 80:10:10 | 0.1 | 0.1 | | 3 |
| E32 | 2-EHA:SA:HBA | 64:30:6 | 0.1 | 0.1 | | 3 |
| E33 | 2-EHA:TBA:HBA | 84:10:6 | 0.1 | 0.1 | 3 | |
| E34 | 2-EHA:TBA:HBA | 79:15:6 | 0.1 | 0.1 | 3 | |
| E35 | 2-EHA:TBA:HBA | 74:20:6 | 0.1 | 0.1 | 3 | |
| E36 | 2-EHA:TBA:HBA | 75:15:10 | 0.1 | 0.1 | 3 | |
| E37 | 2-EHA:IBOA:HBA | 64:30:6 | 0.1 | 0.1 | 3 | |
| E38 | 2-EHA:IBOA:HBA | 84:10:6 | 0.1 | 0.1 | 3 | |

TABLE 8

Peel Adhesion

| | Room Temp | 180° C. for 1 hour |
|---|---|---|
| Ex. No. | (N/in) | (N/in) |
| E29 | 4.65 | 1.90 |
| E30 | 5.12 | 2.27 |
| E31 | 5.90 | 2.93 |
| E32 | 4.20 | 1.60 |
| E33 | 8.58 | 3.68 |
| E34 | 7.26 | 4.66 |
| E35 | 8.03 | 5.06 |
| E36 | 7.43 | 4.82 |
| E37 | 10.91 | 7.44 |
| E38 | 7.29 | 2.77 |

### Examples E39-E42

A series of tape samples that were prepared from pressure sensitive adhesives prepared from an alkyl acrylate, a hydroxyl acrylate, a reinforcing monomer (NVP) or a UV-activated crosslinker, a crosslinker and a blocked isocyanate were prepared and tested as described above. The compositions are shown in Table 9 and the tape testing results are shown in Table 10.

TABLE 9

| | | | Crosslinking | | Blocked | |
|---|---|---|---|---|---|---|
| | Acrylate | | Components | | Isocyanate | |
| | Components | | L75 | Al(Acac)₃ | BI2 | UV |
| | Monomers | Ratio | (PHR) | (PHR) | (PHR) | curing |
| E39 | 2-EHA:NVP:HBA | 90:2:8 | 0.15 | 0.1 | 6 | |
| E40 | 2-EHA:HBA:AEBP | 91.7:8:0.3 | | 0.1 | 6 | 300 mJ/cm² |
| E41 | 2-EHA:HBA:AA:AEBP | 90:8:2:2 | 0.1 | 0.3 | 6 | |
| E42 | 2-EHA:HBA:AA:AEBP | 90:8:2:2 | 0.1 | 0.3 | 6 | 300 mJ/cm² |

TABLE 10

Peel Adhesion

| | Room Temp | 180° C. for 1 hour |
|---|---|---|
| Ex. No. | (N/in) | (N/in) |
| E39 | 9.5 | 2.1 |
| E40 | 6.7 | 1.3 |
| E41 | 23.7 | 4.0 |
| E42 | 5.0 | 4.0 |

### Example E43 and Comparative Examples CE5-CE6

A series of tape samples that were prepared from pressure sensitive adhesives prepared from an alkyl acrylate, a hydroxyl acrylate, a reinforcing monomer (GMA), a crosslinker and a blocked isocyanate were prepared and tested as described above. The compositions are shown in Table 11 and the tape testing results are shown in Table 12.

TABLE 11

| | | | Crosslinking | | Blocked |
|---|---|---|---|---|---|
| | | | Components | | Isocyanate |
| | Acrylate Components | | L75 | Al(Acac)₃ | BI1 |
| | Monomers | Ratio | (PHR) | (PHR) | (PHR) |
| E43 | 2-EHA:BA:GMA:HEA | 48.5:40:10:1.5 | 2 | 0.5 | 5 |
| CE5 | 2-EHA:BA:GMA:HEA | 48.5:40:10:1.5 | 2 | | 5 |
| CE6 | 2-EHA:BA:GMA:HEA | 48.5:40:10:1.5 | | 0.5 | 5 |

TABLE 12

Peel Adhesion

| | Room Temp | 180° C. for 1 hour |
|---|---|---|
| Ex. No. | (N/in) | (N/in) |
| E43 | 8.8 | 4.7 |
| CE5 | 6.8 | 7.9 |
| CE6 | 9.52 | 4.6 |

What is claimed is:

1. A composition comprising:
a curable adhesive composition that upon curing forms a (meth)acrylate pressure sensitive adhesive, the curable adhesive composition comprising:
a curable composition comprising:
at least one first monomer comprising an alkyl (meth)acrylate comprising 4-12 carbon atoms;
at least one second monomer comprising a hydroxyl-functional (meth)acrylate;
at least one crosslinking moiety; and
at least one initiator; and
a thermally de-bonding composition comprising:
at least one blocked multi-functional isocyanate; and
at least one metal salt catalyst;
wherein the Peel Adhesion of the cured (meth)acrylate pressure sensitive adhesive upon heating to at least 180° C. for 1 hour is reduced by at least 15%.

2. The composition of claim 1,
wherein the curable composition comprises 70-98.9% by weight of the total composition, and comprises:
50-99% by weight of the curable composition of the at least one alkyl (meth)acrylate comprising 4-12 carbon atoms;
1-40% by weight of the curable composition of the at least one hydroxyl-functional (meth)acrylate;
0.1-20 parts by weight per 100 parts of the curable components of the at least one crosslinking moiety; and
at least one initiator; and
the thermally de-bonding composition comprises:
1-20% by weigh of the total composition of the at least one blocked multifunctional isocyanate; and
1-10% by weight of the total composition of the at least one metal salt catalyst.

3. The composition of claim 1, wherein the curable composition further comprises at least one reinforcing monomer, wherein the reinforcing monomer comprises an acidic monomer, a non-acidic polar monomer, or a high Tg monomer with a homopolymer Tg of greater than 20° C.

4. The composition of claim 3, wherein the reinforcing monomer comprises:
0-49% by weight of the curable composition.

5. The composition of claim 1, wherein the initiator comprises a photoinitiator.

6. The composition of claim 1, wherein the crosslinking moiety comprises a multi-functional (meth)acrylate, a compound comprising at least 2 hydroxyl-reactive groups, or a photo-activatable crosslinking moiety.

7. The composition of claim 1, wherein the at least one blocked multi-functional isocyanate comprises an amino-blocked polyisocyanate.

8. The composition of claim 1, wherein the at least one metal salt catalyst comprises aluminum acetonate, dibutyltin dilaurate, bismuth carboxylate, zirconium acetyl acetonate, dibutyltin diacetate, antimony acetate, calcium octoate, titanium tetrabutoxide and chromium dionate or combinations thereof.

9. The composition of claim 1, wherein the Peel Adhesion of the cured (meth)acrylate pressure sensitive adhesive upon heating to at least 180° C. for 1 hour is reduced by at least 40%.

10. An article comprising:
a substrate with a first major surface and a second major surface; and
a cured adhesive disposed on at least a portion of the second major surface of the substrate, the adhesive comprising a cured adhesive composition, the adhesive composition comprising:
a curable composition that upon curing forms a (meth)acrylate pressure sensitive adhesive, the curable composition comprising:
at least one first monomer comprising an alkyl (meth)acrylate comprising 4-12 carbon atoms;
at least one second monomer comprising a hydroxyl-functional (meth)acrylate;
at least one crosslinking moiety; and
at least one initiator; and
a thermally de-bonding composition comprising:
at least one blocked multifunctional isocyanate; and
at least one metal salt catalyst;
wherein the Peel Adhesion of the cured (meth)acrylate pressure sensitive adhesive upon heating to at least 180° C. for 1 hour is reduced by at least 15%.

11. The article of claim 10, wherein the substrate comprises a film, a tape backing, a foam, a release liner, or a rigid plate.

12. The article of claim 10, wherein upon applying the article to a surface, the Peel Adhesion of the cured (meth)acrylate pressure sensitive adhesive layer is at least 2.5 Newtons/inch.

13. The article of claim 10, wherein the curable composition comprises:
70-98.9% by weight of the total adhesive composition, and comprises:
50-99% by weight of the curable composition of the at least one alkyl (meth)acrylate comprising 4-12 carbon atoms;
1-40% by weight of the curable composition of the at least one hydroxyl-functional (meth)acrylate;
0.1-20 parts by weight per 100 parts of the curable components of the at least one crosslinking moiety;
and at least one initiator; and
the thermally de-bonding composition comprises:
1-20% by weigh of the total composition of the at least one blocked multifunctional isocyanate; and
1-10% by weight of the total composition of the at least one metal salt catalyst.

14. The article of claim 10,
wherein the curable composition further comprises at least one reinforcing monomer, wherein the reinforcing monomer comprises an acidic monomer, a non-acidic polar monomer, or a high Tg monomer with a homopolymer Tg of greater than 20° C.

15. The article of claim 14, wherein the reinforcing monomer comprises:
0-49% by weight of the curable composition.

16. The article of claim 10, wherein the initiator comprises a photoinitiator.

17. The article of claim 10, wherein the crosslinking moiety comprises a multi-functional (meth)acrylate, a compound comprising at least 2 hydroxyl-reactive groups, or a photo-activatable crosslinking moiety.

18. The article of claim 10, wherein the at least one blocked multi-functional isocyanate comprises an amino-blocked polyisocyanate.

19. The article of claim 10, wherein the at least one metal salt catalyst comprises aluminum acetonate, dibutyltin dilaurate, bismuth carboxylate, zirconium acetyl acetonate, dibutyltin diacetate, antimony acetate, calcium octoate, titanium tetrabutoxide and chromium dionate or combinations thereof.
